(19) United States
(12) Patent Application Publication
(10) Pub. No.: US 2014/0231404 A1
(43) Pub. Date: Aug. 21, 2014

(54) Chest of Drawers with Heating Elements

(71) Applicant: Adam Benjamin Struck, Boca Raton, FL (US)

(72) Inventor: Adam Benjamin Struck, Boca Raton, FL (US)

(21) Appl. No.: 14/264,996

(22) Filed: Apr. 29, 2014

(51) Int. Cl. H05B 3/00; A47B 88/04

(52) U.S. Cl. CPC H05B 3/00; A47B 88/0414
USPC 219/218

(57) ABSTRACT

A chest of drawers is disclosed with a heating element incorporated therein. The chest of drawers has at least one drawer, which has a heating element incorporated into a portion thereof. The heating element may be disposed on or embedded in a base portion of the drawer, or attached externally to the entire chest of drawers such that, when activated, the heating element warms clothing that is placed in the drawer or the chest. The heating element may employ a plurality of embedded insulated wires or carbon fiber wires. The wires may be arranged on a top surface of the base of the drawer. Alternatively, the wires may be embedded in the base portion of the drawer. Alternatively, the wire may surround the external casing of the chest of drawers. The heating element may be toggled by way of a sensor detecting a stimulus.

### FIELD OF THE DISCLOSED TECHNOLOGY

The disclosed technology relates generally to furniture and, more specifically, to a heating element incorporated into a piece of furniture used for storing clothes.

### BACKGROUND OF THE DISCLOSED TECHNOLOGY

Heating pads and blankets are well known in the art. Such apparatuses are used to ease pain and provide warmth during cold conditions. Similarly, heated towel racks are sometimes used in bathrooms to provide a warm towel to an individual who has just showered or bathed. The warm towel provides comfort and maintains the body temperature of the individual.

Often, individuals will place clothing into a dryer immediately before getting dressed, so the clothing will be warm. Given the fact that dryers use a a large amount of electricity and are often not located within or near a bedroom, this process may not be feasible fir many individuals. Thus, needed in the art is a way to conveniently warm clothing just prior to its being worn by an individual.

### SUMMARY OF THE DISCLOSED TECHNOLOGY

Therefore, it is an object of the disclosed technology to provide a method and an apparatus for storing and warming clothing just prior to the clothing being worn by an individual by activating a heating element upon detection of a stimulus or occurrence of an event.

As such, in an embodiment of the disclosed technology, a piece of furniture has at least one removable drawer storing contents therein. A “drawer” is defined as any generally box-shaped enclosure that fits into a piece of furniture in such a way that it can be drawn out to allow for easy access to its contents. A “piece of furniture” is defined as any movable object which may have drawers, cabinets, shelves, cubbies and/or any other enclosures for storing objects therein. A heating element may be incorporated into an inner base portion of the drawer. The heating element may be coupled to a power source. A “heating element” is defined as any object which converts electrical energy into heat. A switch may be electrically coupled to the heating element. A “switch” is defined as any electromechanical component that can open or close an electrical conduit for electrical current.

A stimulus-receiving device may be operatively coupled to the switch. The receiving of a predefined stimulus may toggle the switch, thereby toggling a state of the heating element. A “stimulus” is defined as a detectable change in an internal or external environment. The stimulus may be a change that is capable of being detected, such as, for example, a sound, a change in intensity of light, a measured passage of time (timer—as defined below), or a change in temperature. Therefore, a “stimulus-receiving device” is any sensor that measures a physical quantity and converts it into a signal which can be read by an observer or an electronic instrument, such as a switch. The stimulus-receiving device may be a light sensor, which, after a pre-configured period of darkness or dormancy, detects an increase in luminosity or intensity of light corresponding to a rising sun. The period of darkness may be any finite time period, such as, for example, four hours. Upon detection, the light sensor may cause toggling of the switch. A “light sensor” is defined as a device which measures intensity and/or luminosity of Hot, and detects changes in intensity and/or luminosity of light. In another embodiment, the light sensor may detect a sudden increase in luminosity or intensity which may be indicative of a light being switched on or a curtain being drawn open in a room.

In a further embodiment of the disclosed technology, the piece of furniture may employ a temperature sensor. The temperature sensor may detect a large change in ambient temperature corresponding to timed activation of a room heating system, and may toggle a state of the switch in response thereto. A “temperature sensor” is defined as any device which measures a temperature and/or a change in temperature in the environment in which the sensor is placed. The piece of furniture may also employ a temperature sensor within the drawer for communicating with the switch, in order to maintain a temperature within the drawer within a specified temperature range. The temperature range may be, for example, between 120° F. and 140° F.

In still a further embodiment, a timer may be used for setting a time period during which the heating elements will be powered on automatically. A “timer” is defined as a specialized type of clock device for measuring time intervals. The tinier may turn of the heating element after the heating element has been functioning for a specified length of time.

In another embodiment of the disclosed technology, a method is used for warming clothing. The method is carried out, not necessarily in the following order, by: a) inserting clothing into a drawer of a chest of drawers; b) detecting, with a sensor, a first stimulus; c) turning on a heating element upon detection of the stimulus, the heating element disposed in or on a base portion of the drawer of the chest of drawers; d) heating the clothing using the heating element; and e) turning off the heating element upon a second stimulus.

The first stimulus may be an automatic timer sending electricity to the heating pad at a pre-determined period of time. The first stimulus may be an increase in ambient light as detected by a light sensor associated with the chest of drawers. The second stimulus may be the lapse of a specified time period as determined by a timer. The second stimulus may alternatively be a decrease in ambient light as detected by the light sensor associated with the chest of drawers. The temperature of the heating element may be maintained in a range of between 120° F. and 160° F. while the heating element is on. The heating element may be disposed within the base portion of the drawer. That is, the base portion of the drawer may be formed of a material that may incorporate a heating element therein, or depressed area therein adapted for placement of a heating pad.

The disclosed method may employ additional steps of: a) maintaining, using a temperature sensor, a temperature within the drawer to be within a specific range; and/or b) setting, using an input, a duration and a temperature associated with the step of heating the clothing using the heating element.

In embodiments of the disclosed technology, the heating element may be fixedly attached to an outside of a drawer or outside of a chest of drawers (a device housing multiple drawers). The interior of a drawer is defined as a space between sides which holds contents comprising or consisting of clothing. An exterior is defined as a side opposite an interior side. An interior of a chest is defined as a part thereof which contains or comprises at least two drawers, and an exterior side of a chest is defined as a side on the outside of the chest.

It should be understood that the use of “and/or” is defined inclusively such that the term “a and/or b” should be read to include the sets: “a and b,” “a or b,” “a,” “b.”

### BRIEF DESCRIPTION OF THE DRAWINGS

FIG. 1 is a perspective view of a chest of drawers, according to an embodiment of the disclosed technology.

FIG. 2a is a blown-apart view of a drawer with a heating element embedded therein, according to an embodiment of the disclosed technology.

FIG. 2b is a stand-alone view of drawers with a heating element embedded therein, according to an embodiment of the disclosed technology.

FIG. 2c is a stand-alone view of a drawer with an externally disposed heating element, according to an embodiment of the disclosed technology.

FIG. 3a is a blown apart view of a drawer with external heating element installed therein, according to an embodiment of the disclosed technology.

FIG. 3b is a stand-alone view of drawers with an external heating element placed therein, according to an embodiment of the disclosed technology.

FIG. 3c is a blown apart of a drawer with an external heating element placed therein, according to an embodiment of the disclosed technology.

FIG. 4 is a back perspective view of a chest of drawers, according to an embodiment of the disclosed technology.

FIG. 5 is a flowchart outlining steps of a method of an embodiment of the disclosed technology.

FIG. 6 is a high level block diagram of a device that may be used to carry out an embodiment of the disclosed technology.

### DETAILED DESCRIPTION OF EMBODIMENTS OF THE DISCLOSED TECHNOLOGY

In an embodiment of the disclosed technology, a chest of drawers has a heating element incorporated therein. The chest of drawers has at least one drawer or compartment having a heating element incorporated into a portion thereof. The heating element may be disposed on or in a base portion of the drawer, such that, when activated, the heating element warms clothing that is placed in the drawer. The heating element may employ a plurality of embedded insulated wires or carbon fiber wires. The wires may be arranged on a top surface of the base of the drawer. Alternatively, the wires may be embedded in the base portion of the drawer. The heating element may be toggled by way of a sensor detecting a stimulus. The stimulus may be light, sound and/or motion. Alternatively, the heating element may be electrically coupled to a timer or clock to toggle heating at a specified time or after a specified time interval.

Embodiments of the disclosed technology will become clearer in view of the following description of the drawings.

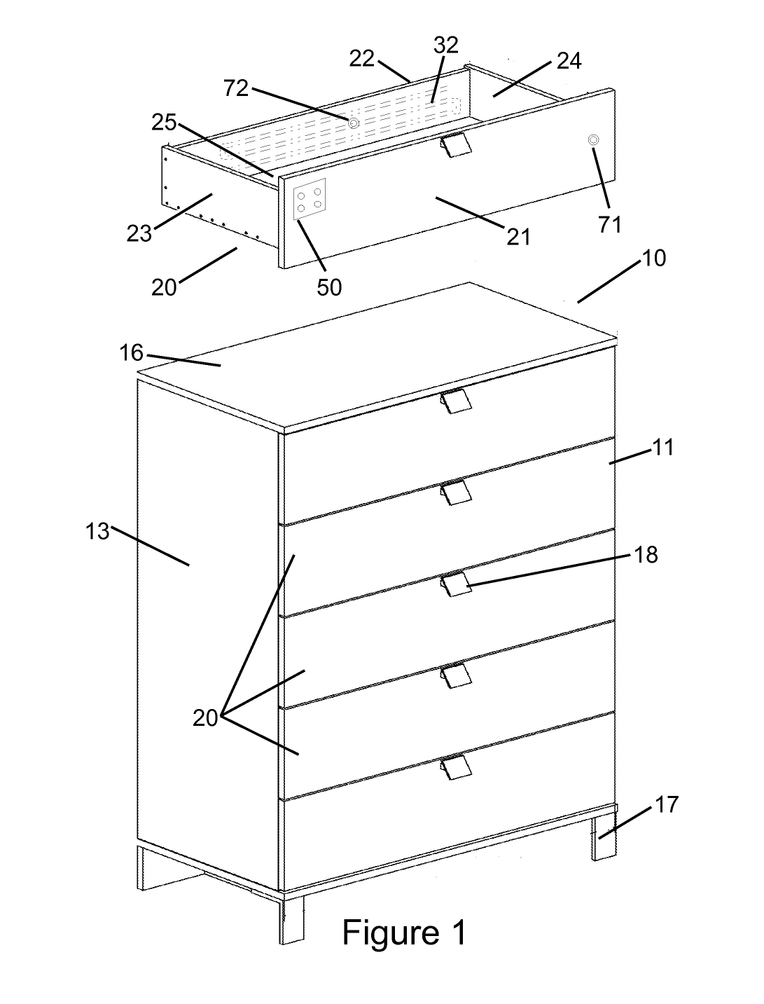

FIG. 1 is a perspective view of a chest of drawers, according to an embodiment of the disclosed technology. The chest 10 generally has a front 11, back 15 (not shown), left side 13, right side 14 (not shown), top 16 and bottom 15 (not shown) surfaces. The chest 10 generally has a number of drawers 20, and a plurality of legs 17 for supporting the chest on a surface. Each drawer 20 is a box-shaped container that fits into the chest 10 in such a way that it can be drawn out horizontally to reach the contents of the drawer. A handle 18 or knob is affixed to a front side 21 of each drawer 20 to pull the drawer out of the chest 10. The chest 10 and/or drawers 20 may be formed of any type of material, such as wood, wood composite, sheet metal, plastic and/or any combination thereof. Further, the chest 10 design and dimensions depicted in FIG. 1 are merely an example, and any conceivable piece of furniture may be used in conjunction with the disclosed technology. Thus, for example, the disclosed technology may conceivably be used on a bureau, desk, armoire, nightstand, dresser, vanity, bed frame with drawers, linen closet, or any other piece of furniture having drawers, cabinets, trunks, and/or shelves for storing clothing, linens, and/or accessories. Clothes, linens, and/or other worn accessories are placed within the drawer 20 to be stored in the chest 10.

The drawer 20 generally has a front 21, back 22, and sides 23, 24. The drawer 20 further has a base 2.5 onto which clothing and other stored accessories may be placed. The base 25 may incorporate a heating element 30. The heating element 30 may employ a plurality of embedded rows and/or columns of insulated and/or heat-generating wires disposed in a suitable medium, such as a polymer, plastic, or wood with a high melting or burning temperature. A “heating element” is defined as any object which converts electrical energy into heat. The heating element may incorporate an electrical resistor through which an electrical current may be directed. The electrical current produces heat energy under the principle of joule heating. Joule heating is defined as the process by which the passage of an electric current through a conductor releases heat. Alternatively, the base 25 may be a standard work, particle board or plywood base, with a heating element 30 resting on atop surface thereof Because the drawers 20 are stacked vertically, the base 25 of an upper drawer may act, to all intents and purposes, as top for a lower drawer. The heating element 30 in this embodiment may be embedded within a fabric blanket or insulated pad, such as those typically used in electric heating pads known in the art. A power cable may extend from a rear portion of the chest 10 and/or the drawer 20. Alternatively, the power cable may extend out of a front or bottom portion of the drawer. In this embodiment, the power cable may be a thin copper laminate which does not obstruct the opening and closing of the drawer. The power cable may be used to provide electricity to the heating element 30.

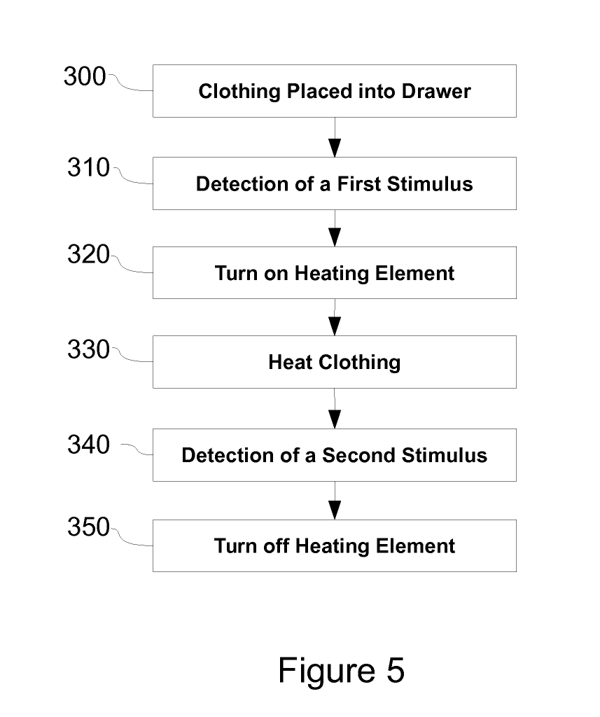

Referring still to FIG. 1, a control panel 50 is disposed on the front side 21 of the drawer 20. The control panel 50 may serve as the nerve center for the heating elements. The control panel 50 may incorporate a processor, non-transitory computer readable storage, and other associated components which are described in further detail with respect to FIG. 5. The control panel 50 may comprise an LCD display and a number of buttons or other inputs. The control panel 50 may utilize a timer component which allows a user to program and configure heating intervals or durations based on the desired preferences of the user. If multiple heating elements 30 are employed (e.g., one heating element associated with each drawer), each of the heating elements may be individually programmed via the control panel 50. The timer may also be configurable based on the day. For example, on weekends a drawer containing work clothes may not be warmed or the time at which a given heating element is triggered may be pushed back. The control panel 50 may also be used to manually or automatically turn the heating element on or off. Still further, a control panel may be disposed inside the drawer 20 (as opposed to being on an exterior thereof). In this embodiment, a chest 10 may be retrofitted with a heating element, such as fur example, a standard heating pad available in the market.

In an alternative embodiment of the disclosed technology, the control panel 50 may be disposed on an interior region of the chest 10, such as, for example, within a top drawer 20 in a manner that it is hidden from plain view. The control panel 50 may also employ a temperature control component which regulates and maintains the temperatures specified by the user. The temperature control component may further employ an emergency shut-off that turns the entire system off if the temperature climbs above a threshold that is dangerous or harmful to humans on touch.

Referring still to FIG. 1, a first light sensor 71 may also be disposed on an exterior of the chest 10. The light sensor 71 may be electrically coupled to the control panel 50. The light sensor 71 may be configured to detect a change in luminosity or increase in ambient light present in the general vicinity of the chest 10. The sensor 71 may cause the control panel to power on the heating element 30 upon detection of increased light being captured by the sensor. Thus, the detected light would, in all likelihood, be an indication of an individual switching the lights on in a room or opening window shades in a room, thereby indicating that the user may be changing his or her clothing in the near feature. Likewise, the light sensor may also detect a decrease in ambient light. The decrease in light would presumably be an indication of an individual leaving the room or going to sleep in the room. Thus, the detection of a decrease in ambient light intensity or luminosity may trigger a powered-off or standby mode for the control panel and the heating element. In a further embodiment of the disclosed technology, the heating element may be disposed on the back panel of the chest of drawers. The heating element may be disposed on the interior side or exterior side of the back panel, as opposed to the back panel of the drawer.

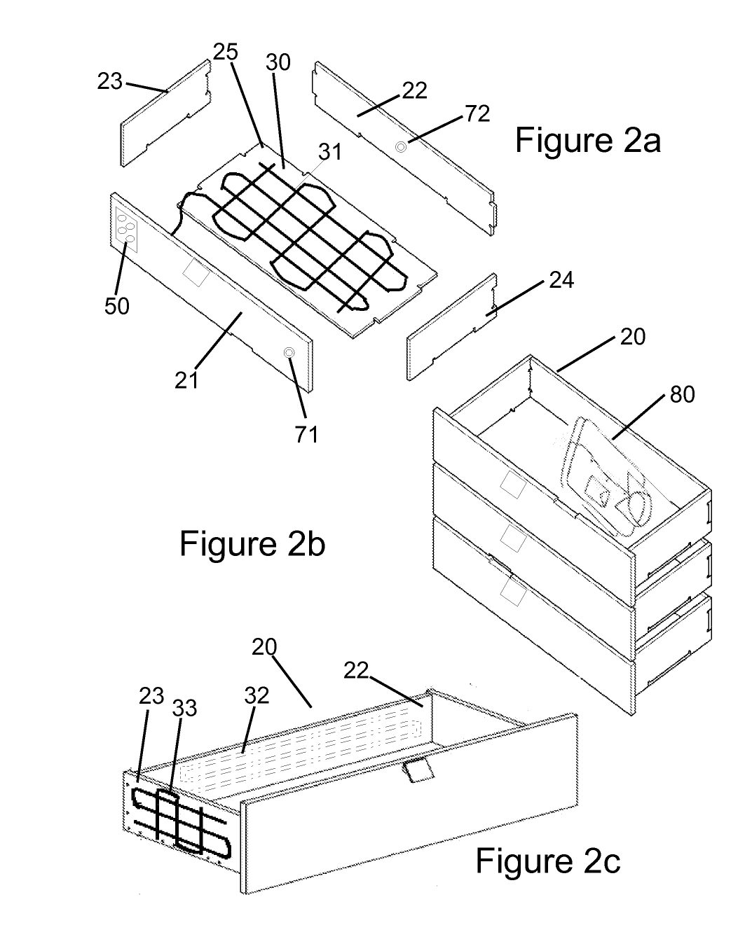

FIG. 2a is a blown-apart view of a drawer with a heating element embedded therein, according to an embodiment of the disclosed technology. FIG. 2b is a stand-alone view of drawers with a heating element embedded therein, according to an embodiment of the disclosed technology. The drawer 20 generally has a metallic conductive sheet or wire 31 arranged in a grid or spiral shape on or in the base 25. The wire 31 may be weaved back and forth within or above the base 25, such that the entire surface area of the base radiates heat. In a further embodiment of the disclosed technology, interior surfaces of the front 21, back 22, and sides 23, 24 of the drawer may also be lined with heating elements or have heating elements disposed therein. Furthermore, if the bases 25 of each drawer 20 are heated, the heat may radiate upwards into the interior of the drawer as well as downwards, onto the contents of the drawer below. Thus, heat may be projected downwards onto underlying clothing. In this embodiment, heat emanates from all six sides of the rectangular interior of the drawer 20.

A temperature sensor or thermostat 60 (not shown) may be disposed at an interior region of the drawer 20. The sensor 60 may constantly measure the ambient temperature within the drawer 20. The sensor 60 may be employed to maintain the temperature within a suitable range. That is, the temperature may be maintained at a level that is safe and comfortable to humans, without burning or melting clothing parts or accessories or creating a fire hazard. The temperature within the drawer may be maintained between 86° F. and 176° F., depending on user preference. In further embodiments, the suitable temperature may be maintained within a smaller range, such as, for example 100° F. to 120° F.

In still another embodiment of the disclosed technology, a second light sensor 72 may be disposed on an interior portion of each drawer 20. The second light sensor 72, like the first Hot sensor 71, may be configured to detect changes in intensity of ambient light. The second light sensor 72 may detect light as the drawer 20 is opened and closed. Thus, in one embodiment, if the heating element 30 is turned on by an individual, the detection of light via the second light sensor 72 may turn the heating element off. That is, the second light sensor 72 will detect ambient light when the drawer is opened. Presumably clothing will be removed from the drawer 20 upon the drawer being opened, rendering the heating element unneeded once the drawer is opened, so it may be powered off either immediately or shortly after the drawer is detected to be ajar.

In an alternative embodiment, the heating element 30 may be powered on upon detection of light by the second light sensor 72. Thus, the drawer 20 being opened is an indication to the control panel 50 that a user plans to take clothing out of that drawer. In this embodiment, the heating element 30 may be switched off when the drawer is closed. In still a further embodiment, detection of the opening and/or closing of drawers may be carried out using magnetic panels, which, when separated, indicate a change in capacitance and therefore trigger an event or change in power state.

FIG. 2c is a stand-alone view of a drawer with an externally disposed heating element, according to an embodiment of the disclosed technology. In this embodiment, the drawer 20 has heating elements 32 & 33 disposed along exterior regions of the drawer. Thus, in this embodiment, heat is conducted through the panels of the drawer 20 and projected onto the contents of thereof. A side heating element 33 is shown abutting the left side panel 23 of the drawer 20. Further, the outline of a back heating element 32 is shown disposed on an exterior surface of the back panel 22 of the drawer 20. The heating elements 32 & 33 may be adhered or fixed to the exterior surfaces of the drawer using fasteners, glue, or any other way of binding two surfaces.

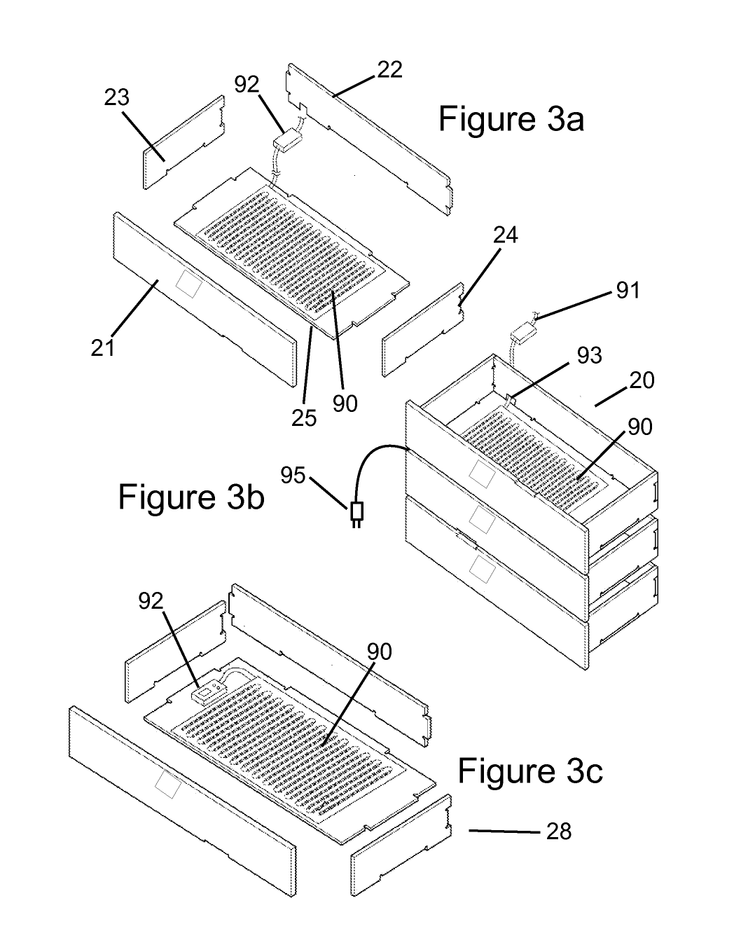

FIG. 3a is a blown apart view of a drawer with an external heating element placed. therein, according to an embodiment of the disclosed technology. FIG. 3b is a stand-alone view of drawers with an external heating element placed therein, according to an embodiment of the disclosed technology. A heating pad 90 has a wire 91 extending therefrom to a control unit 92. The heating pad 90 may be similar to any heating pad known in the art. The heating pad 90 may be formed from an insulated wire or grid inserted into a fabric. The control unit 92 may control the current entering the wires in order to regulate the temperature of the heating pad 90. A power plug 95 and cord is shown extending from an interior of a drawer 20. The power plug 95 may be an alternating current plug for household use.

A portal 93 may be disposed in a back side 22 of the drawer 22 and the backside of the external casing of chest 10. Alternatively, a portal 94 (not shown) may be disposed on the bottom of the external casing of chest 10. The wire 91 may extend through the portal 93 and the external casing of chest 10 or through portal 94. The wire 91 has sufficient slack such that the opening of the drawer is uninhibited. Alternatively, the wire 91 may be coiled along at least a portion of its length in order to provide a degree of flexibility of the length. In another embodiment, the heating pad 90 may alternatively be wired to a main control panel, such as is shown in FIGS. 1, 2a and 2b. The wire between the heating pad 90 and control unit 92, or between the control unit 92 and and an electrical outlet (not shown) maybe be disconnectable. In this manner, one may string an end of a wire through portal 94 (not shown) and a small hole, such as between drawers or between a drawer and the body of a chest of drawers. Such wire may be flat or thin wire in order to enable the drawers to close more fully.

FIG. 3c is a blown apart view of a drawer with an external heating element placed therein, according to an embodiment of the disclosed technology. In this embodiment, the entirety of the heating element system is disposed within the confines of drawer 28. Thus, the heating element 90 is placed into the drawer along with an accompanying control unit 92. The control unit 92, or interior of the heating pad assembly, may further include a battery. The battery powers the heating element, alleviating the need for wires. The heating element 90 and/or the control unit 92 may have an adhesive or hook and loop fasteners on a surface thereof for adhering to an interior surface of the drawer 28 or an exterior surface thereof. No retrofitting, altering or pre-configuration of the chest 10 or drawer 28 is necessary in this embodiment as the heating element 90 and control unit 92 may simply be placed into the drawer 28.

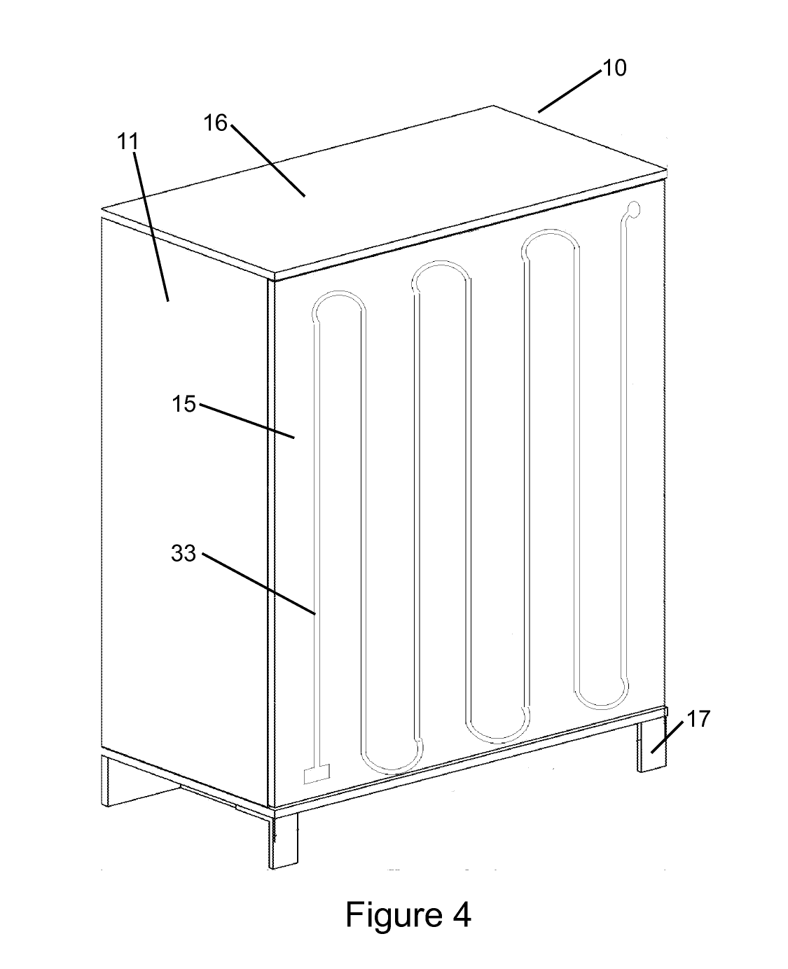

FIG. 4 is a back perspective view of a chest of drawers, according to an embodiment of the disclosed technology. The chest 10 depicted in FIG. 4 represents another embodiment of a heating element configuration of the disclosed technology. In this embodiment, the heating element 33 is disposed on the outer surface of the back panel 15 of the chest 10. Still further, the single heating element 33 may provide heat to all of the drawers of the chest 10. Such a heating element 33 may be retrofitted to any type of furniture used for clothing storage with no modification to the piece of furniture. The heating element 33 may be adhered or fixed to the exterior surfaces of the chest using fasteners, glue, or any other way of binding two surfaces.

FIG. 5 is a flow diagram outlining steps of a method of an embodiment of the disclosed technology. The first step 300 involves clothing, accessories, or other linens being placed into one or more drawers of the chest of drawers. Next, in step 310, a first stimulus is detected using a sensor, switch or other input. Upon detection of the stimulus (such as a timer), in step 320, the heating element is turned on. Once turned on, in step 330, the heating element transmits heat onto and/or into the clothing. The clothing may be warmed to a comfortable temperature. Depending on the time of day, different heating elements disposed within different drawers may be selectively turned on. For example, if the heat-triggering stimulus occurs at night, a drawer containing pajamas and other night-oriented clothing may be heated. Likewise, if the heat-triggering stimulus occurs in the morning, a drawer containing business or work clothing may be heated. The heating elements may be pre-configured by a user to turn on at times specified by the user.

Proceeding with the method, in step 340, a second stimulus is detected. In step 350, the detection of the second stimulus triggers the shut-down of the heating element. In embodiments, the timer may be used as the second stimulus to turn off the heating element after a specified duration has lapsed. The shut-off timer may be employed for safety reasons and/or to reduce power consumption.

The entire method may be automated and pre-configured, using one or more timers associated with the heating elements. The timers may be controlled via a local interface, mobile device, or computer. For example, a mobile application may be used to configure the on/off times and durations of the heating elements. The mobile application may communicate with a node associated with the timers and heating elements using bluetooth or over a wireless network. A user may dictate which heating elements are to be turned on, at which time of day, and for what duration.

In still another embodiment, the entire method may be manually carried out by the user. That is, the user may simply switch one or more heating elements on and off at will. Thus, for example, the user may switch the heating element on just before taking a shower. Then, after the user removes clothing from one or more of the drawers, the user may switch the heating elements off.

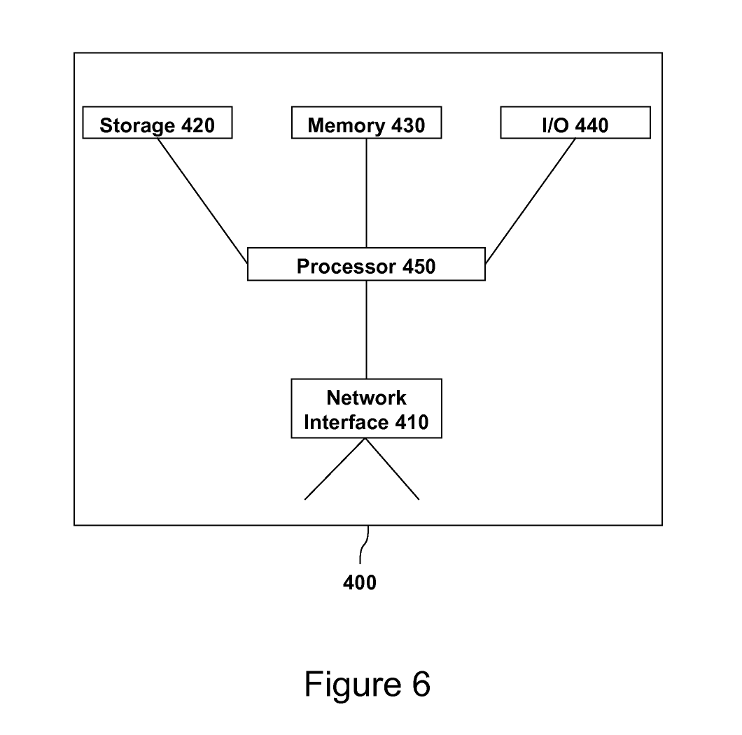

FIG. 6 is a high level block diagram of a device that may be used to carry out an embodiment of the disclosed technology. Node 400 comprises a processor 450 that controls the overall operation of the computer by executing the transceiver's program instructions which define such operation. The node's program instructions may be stored in a storage device 420 (e.g., magnetic disk, database) and loaded into memory 430 when execution of the console's program instructions is desired. Thus, the node's operation will be defined by the transceiver's program instructions stored in memory 430 and/or storage 420, and the console will be controlled by processor 450 executing the console's program instructions.

A node 400 also includes one or a plurality of input network interfaces for communicating with other devices via a network (e.g., the Internet). A node 400 also includes one or more output network interfaces 410 fir communicating with other devices. Bidirectional transceiver 400 also includes input/output 440 representing devices which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device for illustrative purposes. The entirety of the electrical components described, including the heating element, may operate at 110/120 or 220/240 volts and 50 watts in an embodiment of the disclosed technology. It should also be understood by one skilled in the art that the method and devices depicted in FIGS. 1 through 5 may be implemented on a device such as is shown in FIG. 6.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

I claim:

1. Apiece of furniture comprising:
at least one removable drawer storing contents therein;
a heating element incorporated into an inner base portion of said drawer, said heating element coupled to a power source;
a switch electrically coupled to said heating element; and
a stimulus receiving device operatively coupled to said switch; whereby a predefined stimulus toggles said switch.

2. The piece of furniture of claim 1, further comprising a temperature sensor within said drawer, wherein a large change in ambient temperature corresponding to timed activation of a room heating system toggles said state of the switch.

3. The piece of furniture of claim 2, wherein said temperature sensor communicates with said switch to maintain a temperature within said drawer within a specified temperature range.

4. The piece of furniture of claim 2, wherein said specified temperature range is between 100° F. to 176° F.

5. The piece of furniture of claim 1, wherein a first said stimulus is an automatically preset timer sending electricity to said heating element at a pre-determined period of time.

6. The piece of furniture of claim 5, wherein a second said stimulus is a cessation of electricity to said heating element after a specified time duration having elapsed, as determined by an automatically present timer.

7. A method of warming clothing, the method comprising:
inserting clothing into a drawer of a chest of drawers;
detecting, with a sensor, a first stimulus;
turning on a heating element upon detection of said stimulus, said heating element disposed in or on a base portion of said drawer of said chest of drawers;
heating said clothing using said heating element, and
turning off said heating element upon sensing a second stimulus.

8. The method of claim 7, wherein said clothing is inserted into a piece of furniture selected from the group consisting of a trunk, bureau, desk, armoire, nightstand, dresser, vanity, and bed frame with drawers.

9. The method of claim 7, wherein said first stimulus is received from an automatically preset timer sending electricity to said heating element at a pre-determined period of time.

10. The method of claim 8, wherein said second stimulus is a cessation of electricity to said heating element after a specified time duration having elapsed, as determined by an automatically present timer.

11. The method of claim 7, wherein said first stimulus is an increase in ambient light as detected by a light sensor associated with said chest of drawers.

12. The method of claim 7, wherein said second stimulus is a decrease in ambient light as detected by said light sensor associated with said chest of drawers.

13. The method of claim 7, wherein a temperature of said heating element maintained within a temperature range of 100° F. to 176° F. while said heating element is on.

14. The method of claim 7, further comprising a step of: setting, using an input, a duration and a temperature associated with said step of heating said clothing, using said heating element.

15. The method of claim 7, wherein said heating element is embedded within said base portion of said drawer.

16. The method of claim 7, wherein said heating element is placed on top of said base portion of said drawer.

17. A method of warming clothing, the method comprising:
inserting clothing into a drawer of a chest of drawers;
detecting, with a sensor, a first stimulus;
turning on a heating element upon detection of said stimulus, said heating element fixedly attached outside of said drawer of said chest of drawers, wherein said heating element heats through said drawer into an interior area thereof;
heating said clothing using said heating element, and
turning of said heating element upon receiving a second stimulus.

18. The method of claim 17, wherein said heating element is fixedly attached to an exterior side of said chest.

19. The method of claim 17, wherein said first stimulus is an automatically preset timer sending electricity to said heating element at a pre-determined period of time.

20. The method of claim 17, wherein said second stimulus is a cessation of electricity to said heating element after a specified time duration having elapsed, as determined by an automatically present timer.
